(19) United States
(12) Patent Application Publication
(10) Pub. No.: US 2005/0234790 A1
(43) Pub. Date: Oct. 20, 2005

(54) Scaling order matching beyond one processor in exchange systems

(75) Inventor: William T. Newport, Rochester, MN (US)

Correspondence Address: Robert R. Williams;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/824,055

(22) Filed: Apr. 14, 2004

(51) Int. Cl. G06F 17/60

(52) U.S. Cl. 705/35

(57) ABSTRACT

Methods, articles of manufacture, and systems are provided that may be utilized to increase the rate in which orders may be processed for a given security by balancing the trading load over a number of local books. For example, when a monitored amount of order volume for a book reaches a threshold amount, an additional book may be created and the order volume may be distributed among multiple books. As a result, multiple processors may be used to process the orders locally (e.g., at the same exchange), thus increasing order processing bandwidth. When the order volume for the security declines, books (e.g., originally opened to handle an increased order volume) may be closed, as deemed appropriate

### BACKGROUND OF THE INVENTION

1. Field of the Invention

The present invention generally relates to processing securities orders in an exchange and, more particularly, to techniques and systems for scaling order processing capacity on demand.

2. Description of the Related Art

Exchanges accept orders to buy and sell securities, which typically specify the security, a quantity, and price. For example, a buy order (a bid) may be fashioned as ‘BUY 100 shares of IBM at (a maximum price of) 85’, while a sell order (an offer) may be fashioned as ‘SELL 50 IBM at (a minimum price of) 86’. An exchange typically maintains a book for each security, that is a list of pending bids and offers, and-tries to match bids to offers to affect a trade.

FIG. 1 illustrates a conventional exchange 110₁, with a single book 120 assigned to each asset (e.g., book 120ₓ assigned to asset X, book 120_{z} assigned to asset Z, etc.) and orders for a given book are typically processed by a single processor or processing thread. For many securities, there are several places available to buy and sell the security, for example, including other “foreign” exchanges 110_{2 . . . N} (e.g., the Philadelphia and Chicago Stock exchanges may be considered foreign to the New York Stock Exchange). Each exchange 110 typically publishes (sends to the other exchanges 110) their ‘best’ bid/offer for each traded security (commonly referred to as the top of the book). The exchanges 110 use this information to try to match orders from their local traders with those of others trading in other exchanges 110, in an effort to provide their local traders with the best possible price for their order.

Hence, orders processed at an exchange 110 may originate locally or may be received (via an interface 130) from foreign exchanges 110_{2 . . . N}. In any case, trading rules typically force orders to be processed serially for a given security or book 120, for example, to ensure fair trading and that orders are processed in the order in which they are received. In a conventional exchange, this requirement leads to the performance limitation that the maximum rate in which orders are processed per book is limited by a single processor. This limitation in order processing leads to delays, resulting in market inefficiency, for example, exhibited as traders not receiving the best price for their orders and orders being resubmitted.

Accordingly, a need exists for techniques for processing market orders that overcome this limitation and allow orders typically processed serially to be processed in parallel, preferably while still adhering to conventional market trading rules.

### SUMMARY OF THE INVENTION

The present invention generally provides methods, articles of manufacture, and systems for dynamically allocating resources for processing orders related to a security.

One embodiment provides a method for dynamically scaling order processing in a securities exchange. The method generally includes maintaining one or more books for a security at the exchange, wherein the one or more books each list orders related to the security, monitoring the volume of orders related to the security received at the exchange, varying the number of books maintained for the security based on the monitored volume of orders, and distributing orders related to the security and received at the exchange among the books maintained for the security.

Another embodiment provides a computer-readable medium containing a program for dynamically scaling order processing in a securities exchange. When executed by a processor the program performs operations generally including maintaining one or more books for a security at the exchange, wherein the one or more books each list orders related to the security, monitoring the volume of orders related to the security received at the exchange, varying the number of books maintained for the security based on the monitored volume of orders, and distributing orders related to the security and received at the exchange among the books maintained for the security.

Another embodiment provides an exchange capable of dynamically allocating resources for processing orders related to a security. The exchange generally includes one or more books maintained for the security at the exchange, each listing orders related to the security. The exchange also includes an executable component configured to monitor a volume of orders related to the security received at the exchange, vary the number of books maintained for the security based on the monitored volume of orders, and distribute orders related to the security and received at the exchange among the books maintained for the security.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a conventional securities exchange system.

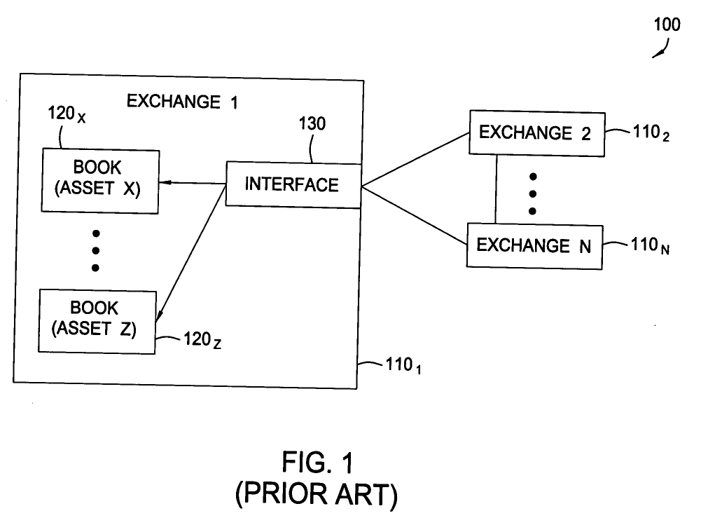

FIG. 2 illustrates an exemplary securities exchange system in accordance with the present invention.

FIG. 3 illustrates an exemplary securities book in accordance with embodiments of the present invention.

FIG. 4 is a flow diagram of exemplary operations for dynamically scaling the number of securities book for a given security based on trading load.

FIG. 5 illustrates various schemes for distributing books among multiple servers.

### DETAILED DESCRIPTION OF THE PREFERRED EMBODIMENTS

Embodiments of the present invention may be utilized to increase the rate in which orders may be processed for a given security by balancing the trading load over a number of local books. For example, when a monitored amount of order volume for a book reaches a threshold amount, an additional book may be created and the order volume may be distributed among multiple books. As a result, multiple processors may be used to process the orders locally (e.g., at the same exchange), thus increasing order processing bandwidth. When the order volume for the security declines, books (e.g., originally opened to handle an increased order volume) may be closed, as deemed appropriate.

As used herein, the term trader generally refers to any entity capable of initiating an order for a security, and may refer to a human trader or a machine. As used herein, the term exchange generally refers to any system established to allow traders to trade any type of securities. While embodiments of the present invention may be used to trade any type of security, to facilitate understanding, embodiments of the present invention will be described with reference to trading stock as a specific, but not limiting, application example.

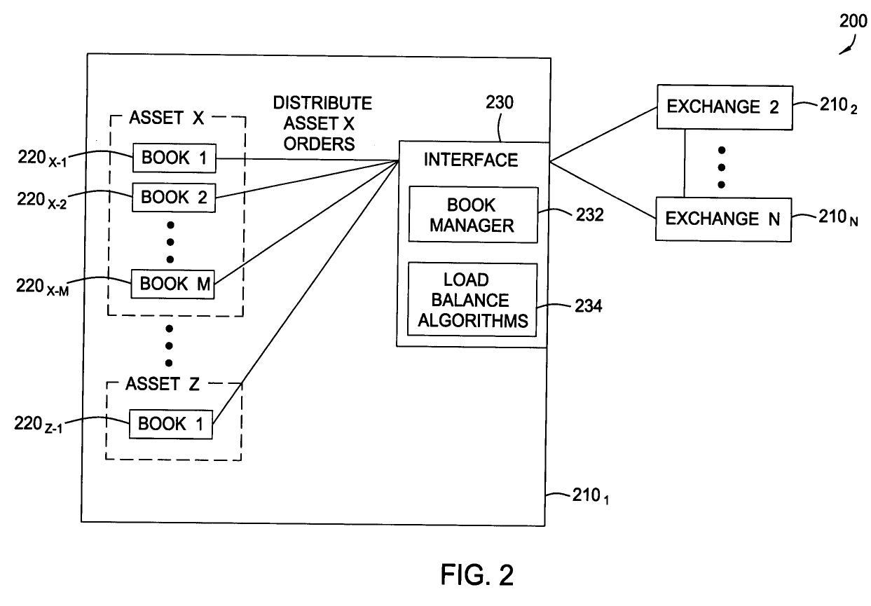

One embodiment of the invention is implemented as a program product for use with a computer system for example, used to implement an exchange 210 shown in FIG. 2 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature

### An Exemplary Exchange System

FIG. 2 illustrates an exemplary exchange 210₁ in accordance with embodiments of the present invention. As illustrated, for an exemplary security “asset X” multiple books 220_{X-1} . . . 220_{X-M} may be maintained at any given time, for example, with the total number of books M depending on a current order volume for asset X (which may be defined, as a number of orders for asset X received at the exchange 210₁ over a predefined sample period).

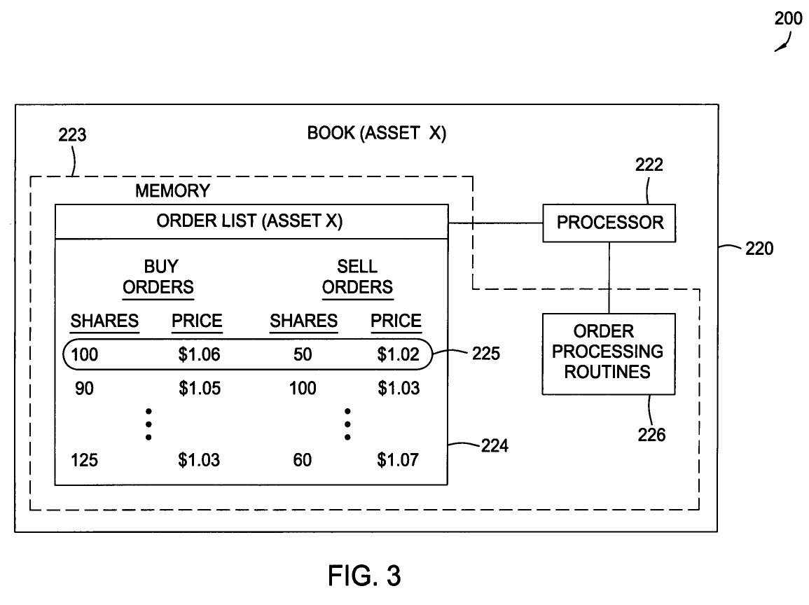

As illustrated in FIG. 3, orders for each book 220 may be processed by at least one processor 222. The processor 222 may maintain, in memory 223, a list 224 or orders, which may be processed according to order processing routines 225. The order processing routines 225 may include any suitable algorithms to match orders in list 224 with other orders in the list 224, or orders from other books 220 at the same local or other foreign exchanges. For example, the order processing routines 225 may include any suitable routines to publish it's best pricing (“top of the book” orders 225), receive best pricing from other books, and communicate with such other books in order to affect trades that satisfy orders in the list 224, while satisfying any conventional or specialized trading rules. In some cases, each order may be time-stamped to allow arbitration between multiple orders that may be matched at any time (e.g., orders received first may be matched first).

Depending on the exact embodiment, each book 220 may be allocated an entire processor 222, or a processing thread thereof. For some embodiments, each book 220 may be managed by a dedicated logical partition that has been allocated some portion of a pool of available processors 222, memory 223, and other system resources. In any case, by dynamically allocating additional resources to process orders for a given security with multiple books, an increase in order processing throughput for that security may be obtained.

### Dynamic Order Processing Scaling Based on Order Volume

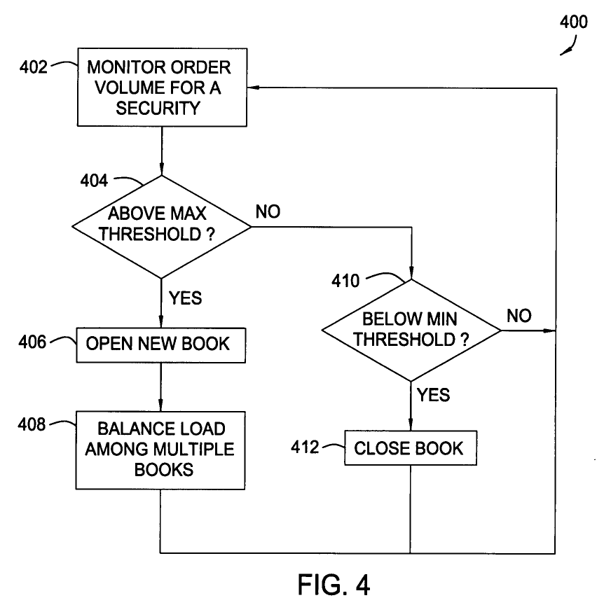

Referring back to FIG. 2, order volume for asset X may be monitored by a book manager 232, which may open/close books 220 as necessary. Upon receiving orders for asset X, the interface 230 may route the orders to the multiple books 220 in an effort to balance the order volume evenly. Operation of the interface 230 and book manager 232 may be described with simultaneous reference to FIG. 4 which illustrates exemplary operations 400 for dynamic order processing scaling based on monitored order volume.

The operations 400 begin, at step 402, by monitoring the order volume of a book or set of books for a given security. Order volume may be monitored, for example, as a number of orders received at the interface 230 divided by a total number of open books over a given sample period. This order volume may be divided by the total number of open books to establish an average order volume per book. For some embodiments, other parameters may be monitored instead of, or in addition to, order volume, such as order execution rate of one or more books 220. While the exact parameter or set of parameters, as well as the length of the sample period, may depend on the exact implementation, to facilitate understanding, the following example will continue to refer to monitoring order volume.

If the order volume exceeds a threshold maximum value (e.g., which may be determined based on a maximum serial speed of any single book processor), as determined at step 404, a new book is opened, at step 406. For some embodiments, different securities may have different corresponding threshold values. Further, for some embodiments, different processors may be used for different books and different threshold values may be applied to different books depending on the processors used. The exact operations required for opening a book may vary depending on the particular implementation. For example, in a multi-partitioned environment, opening a book may involve operations such as creating a new partition to manage the book, allocating one or more processors and other resources to the partition, and the like. As will be described in greater detail below, for some embodiments, multiple books for the same security may be assigned to different servers. Opening a book in such embodiments may involve initiating various processes on a server on which the new book will be opened.

At step 408, the load of incoming orders is then balanced among the multiple books. For some embodiments, the interface 230 may distribute orders among the multiple books as dictated by one or more load balancing algorithms 234, which may specify any number of suitable load balancing algorithms which may range from relatively simple (e.g., a round-robin scheme in which each book receives an order in turn) to more complex (e.g., distributing received orders among multiple books based on actual measured execution rates).

As the order volume for the security declines, it may be desirable to close one or more books (e.g., in order to release processors, allowing them to be used to handle increased traffic for other asset orders). In an effort to prevent books from being rapidly opened and closed a minimum threshold order volume may be established at some level below the maximum threshold. Therefore, if the order volume does not exceed the maximum threshold (step 404) but rather falls below this minimum threshold, as determined at step 410, a book may be closed, at step 412. For some embodiments, at least one book may be kept open for each security, regardless of order volume. For other embodiments, if there are no pending orders for a security, there may no book maintained for that security.

As illustrated, the operations 402-412 may be continuously repeated, for example, while the exchange is open, to continuously monitor order volume and scale order processing accordingly by opening/closing books. While the operations have been described with reference to executable components (e.g., the book manager 232 and/or interface 230), for some embodiments, one or more of the operations 400 may be at least initiated manually. For example, rather than opening or closing books automatically, an administrator may be notified that order volume for a security has exceeded or fallen below a threshold value. The administrator may then have the option (e.g., via an interface) to initiate the opening or closing of books. As an alternative, an administrator may be able to configure a system to automatically vary the number of books maintained for a security, for example, by specifying the maximum and/or minimum threshold volumes, a minimum or maximum number of books to be maintained for the security, a load distribution algorithm to be used, and the like.

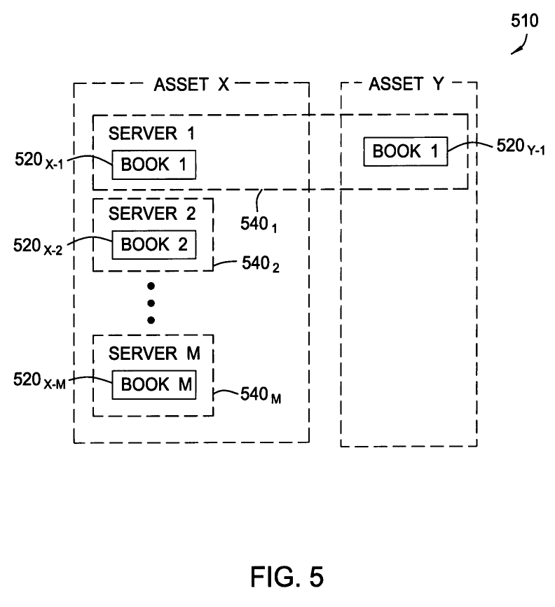

As illustrated in FIG. 5, for some embodiments, an exchange 510 may have multiple servers 540_{1 . . . M} for processing orders. In such embodiments, books 520 for different assets may be distributed among the multiple servers 540 according to different schemes. In some cases, a single server (540₁) may be running books for different assets (e.g., 520_{X-1} and 520_{Y-1}). Further, in some cases, multiple books for the same asset may be running on multiple servers (e.g., each book 520_{X-1} . . . 520_{X-M} of asset X is shown as running on a different server 540₁ . . . 540_{M}). The latter configuration may provide for a reliable exchange, with some level of assurance that orders for an asset will be processed even if one of the servers 540 goes down. If a server does go down, the system may detect an increase in order volume or execution rate for books on the remaining (e.g., functioning) servers 540 and additional books 520 may be opened to compensate for lost order processing throughput. The system would also failover the processing of the books which were running on the failed server 540.

The exact configuration (e.g., size, number of processors, etc.) of each server 540 may vary. For some embodiments, each server 540 may be a multiprocessor machine with multiple logical partitions. As previously described, each logical partition may be allocated one or more processors or portions of processors and other resources. For some embodiments, each book 520 may be assigned to a different logical partition. In such cases, trading among books may be implemented, for example, using known inter partition communications protocols.

While the foregoing is directed to embodiments of the present invention, other and further embodiments of the invention may be devised without departing from the basic scope thereof, and the scope thereof is determined by the claims that follow.

1. A method for dynamically scaling order processing in a securities exchange, comprising:
maintaining one or more books for a security at the exchange, wherein the one or more books each list orders related to the security;
monitoring the volume of orders related to the security received at the exchange;
varying the number of books maintained for the security based on the monitored volume of orders; and
distributing orders related to the security and received at the exchange among the books maintained for the security.

2. The method of claim 1, wherein varying the number of books maintained for the security based on the monitored volume of orders comprises:
determining if the monitored volume of orders related to the security exceeds a maximum threshold value; and
if so, opening a new book for the security.

3. The method of claim 2, wherein opening a new book for the security comprises creating a logical partition.

4. The method of claim 2, wherein opening a new book for the security comprises allocating one or more processors to the new book.

5. The method of claim 2, wherein varying the number of books maintained for the security based on the monitored volume of orders further comprises:
determining if the monitored volume of orders related to the security falls below a minimum threshold value; and
if so, closing one or more books maintained for the security.

6. The method of claim 5, wherein the maximum and minimum threshold values are different.

7. The method of claim 1, wherein maintaining one or more books for the security at the exchange comprises maintaining at least one book for the security on at least two different servers.

8. The method of claim 1, wherein monitoring the volume of orders related to the security received at the exchange comprises dividing the total volume of orders related to the security received at the exchange by the number of books maintained for the security.

9. The method of claim 1, further comprising publishing the top of each book maintained for the security.

10. The method of claim 9, further comprising matching an order listed on one of the books maintained for the security with one of the other books maintained for the security.

11. The method of claim 9, further comprising matching an order listed on one of the books maintained for the security with a book maintained for the security at another exchange.

12. A computer-readable medium containing a program for dynamically scaling order processing in a securities exchange which, when executed by a processor performs operations, comprising:
maintaining one or more books for a security at the exchange, wherein the one or more books each list orders related to the security;
monitoring the volume of orders related to the security received at the exchange;
varying the number of books maintained for the security based on the monitored volume of orders; and
distributing orders related to the security and received at the exchange among the books maintained for the security.

13. The computer-readable medium of claim 12, wherein varying the number of books maintained for the security based on the monitored volume of orders comprises:
determining if the monitored volume of orders related to the security exceeds a maximum threshold value; and
if so, notifying an administrator and providing the administrator with an interface allowing the administrator to open a new book.

14. The computer-readable medium of claim 12, wherein varying the number of books maintained for the security based on the monitored volume of orders comprises:
determining if the monitored volume of orders related to the security exceeds a maximum threshold value; and
if so, opening a new book for the security.

15. The computer-readable medium of claim 12, further comprising providing an interface allowing an administrator to specify the maximum threshold value.

16. The computer-readable medium of claim 12, further comprising providing an interface allowing an administrator to specify how orders related to the security and received at the exchange should be distributed among the books maintained for the security.

17. An exchange capable of dynamically allocating resources for processing orders related to a security, comprising:
one or more books maintained for the security at the exchange, each listing orders related to the security; and
an executable component configured to monitor a volume of orders related to the security received at the exchange, vary the number of books maintained for the security based on the monitored volume of orders, and distribute orders related to the security and received at the exchange among the books maintained for the security.

18. The exchange of claim 17, wherein the one or more books maintained for the security at the exchange comprises:
at least a first book for the security maintained on a first server; and
at least a second book for the security maintained on a second server.

19. The exchange of claim 17, wherein the one or more books are maintained on a computer system having multiple logical partitions.

20. The exchange of claim 19, wherein each book is assigned to a different logical partition.
